(19) United States
(12) Patent Application Publication
(10) Pub. No.: US 2002/0016263 A1
(43) Pub. Date: Feb. 7, 2002

(54) Liquid formulations

(76) Inventors: Jochen Wurtz, Bingen am Rhein (DE); Thomas Maier, Hofheim (DE); Gerhard Schnabel, Elsenfeld (DE); Detlev Haase, Frankfurt (DE)

Correspondence Address: FROMMER LAWRENCE & HAUG LLP, 745 Fifth Avenue, New York, NY, 10151, US

(21) Appl. No.: 09/841,820

(22) Filed: Apr. 25, 2001

(30) Foreign Application Priority Data
Apr. 27, 2000 (DE) 10020671.9-41

(51) Int. Cl. A01N 25/02; A01N 25/04; A01N 25/16

(52) U.S. Cl. 504/362; 504/363

(57) ABSTRACT

The present invention relates to liquid formulations (preparations) comprising a) one or more derivatives of polycarboxylic acids and b) one or more active compounds from the group of the ALS inhibitors.

The invention relates to the field of liquid formulations. In particular, the invention relates to liquid formulations of herbicidally active compounds from the group of the inhibitors of acetolactate synthase (hereinbelow referred to as ALS inhibitors), such as sulfonylureas.

In general, active compounds are not employed as pure substances but, depending on the area of use and the desired physical properties of the use form, in combination with certain auxiliaries, i.e. they are “formulated”. In principle, active compounds can be formulated in various ways, depending on the prevailing biological and/or physicochemical parameters. The following are examples of general possibilities for formulations: wettable powders (WP), oil-in-water or water-in-oil emulsions (EW and EO, respectively), suspensions (SC), suspoemulsions (SE), emulsifiable concentrates (EC), aqueous solutions (SL) or else granules for soil application or for broadcasting, or water-dispersible granules (WG). The formulation types mentioned are known in principle and are described, for example, in: Winnacker-Küchler, “Chemische Technologie” [Chemical Technology], volume 7, C. Hauser-Verlag, Munich, 4th edition, 1986; van Valkenburg, “Pesticide Formulations”, Marcel-Dekker N.Y., 1973; K. Martens, “Spray Drying Handbook”, 3rd ed., 1979, G. Goodwin Ltd. London.

If the active compounds to be formulated are compounds which generally tend to degrade chemically in the dissolved state or in liquid media, preference is usually given to solid formulations such as wettable powders or granules. As described in U.S. Pat. Nos. 4,599,412 and 5,731,264, this is the case, for example, for herbicidally active compounds from the group of the ALS inhibitors, such as metsulfuronmethyl, nico- or rimsulfuron, primisulfuronmethyl, tria-, pro-, amido- or ethoxysulfuron. Accordingly, powder formulations or granules of these herbicides—as, for example, in WO9910857, WO9809516, WO9508265, U.S. Pat. No. 5,441,923, WO9423573, JP05017305, JP04297404, JP04297403 or JP04066509—are already known.

Frequently, when such powder formulations or granules are diluted with water (to prepare the spray liquor), the undissolved fractions in the concentrate cannot be dissolved completely, i.e. the spray liquor is a suspension of the concentrate. However, it is always advantageous if spray liquors are as finely divided as possible, since this reduces the risk of the spray nozzles being blocked and thus quite generally the expenditure for cleaning. Moreover, powder and granule formulations can only be prepared with a relatively high input of energy and technically complicated stirrers, i.e. there are considerable disadvantages even during their preparation.

Liquid suspensions of herbicides of the kind described above in the form of suspension concentrates are already known (FR2576181, EP0205348, EP0237292 or EP0246984). However, in the case of suspensions, too, the active compounds are not dissolved, so that during application of the spray liquor similar problems are encountered as in the case of powder formulations or granules. Moreover, suspension concentrates (SC) and suspoemulsions (SE) are thermodynamically unstable formulations having limited physical storage stability.

Surfactant-free aqueous solutions of sulfonylureas are described in U.S. Pat. Nos. 4,683,000, 4,671,817 and EP0245058, water-free emulsifiable concentrates are described in the publications DE3422824, U.S. Pat. No. 4,632,693, WO9608148 and U.S. Pat. No. 5,597,778. None of these publications give any hints on how to increase the storage stability of the formulations.

Accordingly, it is an object of the present invention to provide a formulation which is stable to degradation and which has favorable performance properties.

Surprisingly, it has now been found that this object is achieved by certain liquid active compound formulations comprising polycarboxylic acid derivatives and, as active compounds, ALS inhibitors such as, for example, sulfonylureas and/or salts thereof.

Accordingly, the present invention provides a liquid formulation (preparation), comprising

a) one or more derivatives of polycarboxylic acids, preferably one or more compounds from the group of the gemini surfactants and/or the sulfosuccinates, and

b) one or more active compounds from the group of the ALS inhibitors, in particular one or more sulfonylureas and/or salts thereof, for examples salts with organic cations based on nitrogen, sulfur or phosphorus and/or inorganic cations such as metal cations.

The liquid formulations of the present invention are preferably herbicidal formulations, for example in the form of emulsion concentrates. The formulations preferably comprise at least one of the active compounds from the group of the ALS inhibitors in dissolved form. Preference is furthermore given to formulations which comprise only one polycarboxylic acid derivative.

If appropriate, the liquid formulations of the present invention may, in addition to components a) and b), also comprise one or more auxiliaries and additives as further components, for example:

(c) additional surfactants and/or polymers,

(d) organic solvents,

(e) agrochemicals which are different from ALS inhibitors, such as herbicides, insecticides, fungicides, safeners, growth regulators or fertilizers,

(f) customary formulation auxiliaries, such as antifoams, evaporation inhibitors, odorants, colorants, antifreeze agents or preservatives,

(g) tank mix components, and/or

(h) additional water.

The polycarboxylic acid derivatives which are present in the formulations according to the invention as component a) are, for example, their esters, amides or salts, and the sulfonates, sulfates, phosphates or carboxylates derived from the polycarboxylic acids or, for example, their esters, amides and salts.

Suitable polycarboxylic acids are, for example, dicarboxylic acids, tricarboxylic acids, tetracarboxylic acids or else carboxylic acids of higher functionality, preferably having 2-20 carbon atoms. Also suitable are polymeric polycarboxylic acids, preferably having molecular weights of up to 2000 g/mol. Examples of polycarboxylic acids are oxalic, malonic, succinic, glutaric, adipic, pimelic, sebacic, azelaic, suberic, maleic, phthalic, terephthalic, mellitic, trimellitic, polymaleic, polyacrylic and polymethacrylic acid and also co- or terpolymers comprising maleic, acrylic and/or methacrylic acid units.

Formally, the polycarboxylic acid esters can be obtained, for example, by reacting the free carboxylic acids with alcohols or alkoxylation products thereof, the esters being produced, for example, by reaction of “activated” carboxylic acids such as carboxylic anhydrides with the alkoxylates or alcohols mentioned. Furthermore, instead of the alcohol alkoxylates, it is also possible to use alkoxylates based on fatty acids, amides or amines for esterification with the polycarboxylic acids mentioned, if they have at least one esterifiable hydroxyl group.

Formally, the polycarboxamides can be produced, for example, by reacting the carboxylic acids with primary or secondary amines or with ammonia. The primary and secondary amines may, for example, have linear, cyclic or branched aromatic, aliphatic and/or cycloaliphatic C₁-C₂₀-hydrocarbon radical substituents, preferably C₁-C₂₀-alkyl radicals, where cycloaliphatic hydrocarbon radicals may contain additional hetero ring atoms, for example morpholine. The C₁-C₂₀-hydrocarbon radicals may also be replaced by (poly)alkylene oxide units, such as (poly)ethylene oxide, (poly)propylene oxide or (poly)butylene oxide. Examples are the amino compounds ethanolamine, diethanolamine, 1-amino-2-propanol or amino-butanol, and their (poly)alkylene oxide adducts. Also suitable are alkyl ethers or alkyl esters prepared from these compounds and having linear or branched aromatic, aliphatic and/or cycloaliphatic mono-, di- or polyfunctional C₁-C₂₀-alcohols. Furthermore suitable are also the oxidation products of the alkoxylated amines, such as glycine and salts thereof.

Suitable polycarboxylic acid salts are, for example, metal salts, such as alkali metal or alkaline earth metal salts, or salts having organic counterions, such as organic ammonium, sulfonium or phosphonium ions.

If the polycarboxylic acids or polycarboxylic acid derivatives such as esters, amides or salts have reactive groups such as double bonds, it is possible to obtain further polycarboxylic acid derivatives by reacting these groups, for example

by oxidation and ring-opening and subsequent reaction with (poly)alkylene oxides and subsequent reaction with phosphoric anhydride or sulfuric acid,

by oxidation and ring-opening and subsequent reaction with alkylating agents, such as dimethyl sulfate,

by oxidation and ring-opening and subsequent reaction with carboxylic acids, such as fatty acids,

by oxidation and ring-opening and subsequent reaction with phosphoric anhydride or sulfuric acid and subsequent reaction with (poly)alkylene oxides, or

by reaction with sodium disulfide or potassium disulfide.

The resulting polycarboxylic acid derivatives for their part can be reacted once or more than once in one of the manners described above—one possibility is, for example, an alkoxylation of an acidic phosphated polycarboxylic ester alkoxylate or polycarboxamide alkoxylate, where the resulting and further reaction products of the polycarboxylic acids or polycarboxylic acid derivatives, too, are suitable derivatives of polycarboxylic acids for the purpose of the present invention.

Preferred components a) are compounds from the group of the gemini surfactants, i.e. amphiphilic compounds having two identical head groups and/or compounds from the group of the sulfosuccinates.

Preferred compounds from the group of the sulfosuccinates correspond to the formula (I):

[chemical structure]

in which

R¹, R² independently of one another are identical or different and are H, substituted or unsubstituted C₁-C₃₀-hydrocarbon radicals, such as C₁-C₃₀-alkyl, or (poly)alkylene oxide adducts,

R³ is a cation, for example a metal cation, such as an alkali metal or alkaline earth metal cation, an ammonium cation, such as NH, alkyl-, alkylaryl- or poly(arylalkyl)phenyl-ammonium cation or (poly)alkylene oxide adducts thereof, or an amino-terminated (poly)alkylene oxide adduct, and

X,Y independently of one another are identical or different and are O or NR⁴, where R⁴is H, a substituted or unsubstituted C₁-C₃₀-hydrocarbon radical, such as C₁-C₃₀-alkyl, C₁-C₃₀-alkyl-C₆-C₁₄-aryl or poly(C₆-C₁₄-aryl-C₁-C₃₀-alkyl)phenyl, dicarboxyethyl or a (poly)alkylene oxide adduct.

Preferred compounds from the group of the gemini surfactants have the formula (II) R⁵—CO—NA—R⁶—NB—CO—R⁷ or (III) R⁵—O—CO—CH(SO₃M)—R⁶—CH(SO₃M)—CO—O—R⁷, in which

R⁵, R⁷ independently of one another are identical or different and are straight-chain, branched or cyclic saturated or unsaturated hydrocarbon radicals having 1 to 30 carbon atoms, preferably 3 to 17 carbon atoms, in particular ethylpentyl, trimethylpentyl, oleyl or propyl,

R⁶ is a spacer of a straight-chain or branched chain having 2 to 100 carbon atoms which contains 0 to 20 oxygen atoms, 0 to 4 sulfur atoms and/or 0 to 3 phosphorus atoms and which has 0 to 20 functional side groups, such as hydroxyl, carbonyl, carboxyl, amino and/or acylamino groups, and which contains 0 to 100, preferably 0 to 20 alkoxy groups, and

A,B independently of one another are identical or different and are polyalkylene oxide radicals having a terminal OH, C₁-C₂₀-alkyl, carboxyethyl, carboxymethyl, sulfonic acid, sulfuric acid, phosphoric acid or betaine grouping, and

M is a cation, for example a metal cation, such as an alkali metal or alkaline earth metal cation, an ammonium cation, such as NH₄, alkyl-, alkylaryl- or poly(arylalkyl)phenyl-ammonium cation or (poly)alkylene oxide adducts thereof, or an amino-terminate (poly)alkylene oxide adduct.

For the purpose of this description, (poly)alkylene oxide adducts are reaction products of starting materials which can be alkoxylated, such as alcohols, amines, carboxylic acids, such as fatty acids, hydroxy- or amino-functional carboxylic esters (for example triglycerides based on castor oil) or carboxamides with alkylene oxides, where the (poly)alkylene oxide adducts have at least one alkylene oxide unit but are generally polymeric, i.e. have 2-200, preferably 5-150, alkylene oxide units. Among the alkylene oxide units, preference is given to ethylene oxide, propylene oxide and butylene oxide units, in particular to ethylene oxide units. The (poly)alkylene oxide adducts described can be constructed of identical or different alkylene oxides, for example of propylene oxide and ethylene oxide arranged in blocks or randomly, and, accordingly, the present application also comprises such “mixed” alkylene oxide adducts.

Derivatives of polycarboxylic acids which are components according to the invention originate particularly preferably from the group of the sulfosuccinates, for example

a1) sulfosuccinate which is esterified once or twice with linear, cyclic or branched aliphatic, cycloaliphatic and/or aromatic alcohols, having, for example, 1 to 22 carbon atoms in the alkyl radical, preferably mono- or dialkali metal sulfosuccinate, in particular mono- or disodium sulfosuccinate, which is esterified once or twice with methanol, ethanol, (iso)propanol, (iso)butanol, (iso)pentanol, (iso)hexanol, cyclohexanol, (iso)heptanol, (iso)octanol (in particular: ethylhexanol), (iso)nonanol, (iso)decanol, (iso)undecanol, (iso)dodecanol or (iso)tridecanol,

a2) sulfosuccinate which is esterified once or twice with (poly)alkylene oxide adducts of alcohols, having, for example,1 to 22 carbon atoms in the alkyl radical and 1 to 200, preferably 2 to 200, alkylene oxide units in the (poly)alkylene oxide moiety, preferably mono- or dialkali metal sulfosuccinate, in particular mono- or disodium sulfosuccinate, which is esterified once or twice with dodecyl/tetradecyl alcohol plus 2-5 mol of ethylene oxide or with i-tridecyl+3 mol of ethylene oxide,

a3) the dialkali metal salt, preferably the disodium salt, of maleic anhydride which has been reacted with one equivalent of an amine or an amino-terminated (poly)alkylene oxide adduct of an alcohol, an amine, a fatty acid, an ester or an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of coconut fatty amine and then sulfonated,

a4) the dialkali metal salt, preferably the disodium salt, of maleic anhydride which has been reacted with one equivalent of an amide or a (poly)alkylene oxide adduct of an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of oleylamide+2 mol of ethylene oxide and then sulfonated, and/or

a5) the tetraalkali metal salt, preferably the tetrasodium salt, of N-(1,2-dicarboxyethyl)-N-octadecylsulfo-succinamate.

Examples of sulfosuccinates of groups a1) to a5) which are commercially available and preferred within the context of the present invention are listed below:

a1) sodium dialkylsulfosuccinates, for example sodium diisooctylsulfosuccinate, commercially available, for example, in the form of the Aerosol® brands (Cytec), the Agrilan® or Lankropol® brands (Akzo Nobel), the Empimin® brands (Albright & Wilson), the Cropol® brands (Croda), the Lutensit® brands (BASF) or the Imbirol®, Madeol® or Polirol® brands (Cesalpinia) or sodium di-(2-ethylhexyl)sulfosuccinates commercially available, for example, in the form of the Triton® brands (Union Carbide) such as Triton® GR-5M and Triton® GR-7ME,

a2) disodium alcohol polyethylene glycol ether semisulfosuccinate, commercially available, for example, in the form of the Aerosol® brands (Cytec), the Marlinat(® or Sermul® brands (Condea), the Empicol® brands (Albright & Wilson), the Secosol® brands (Stepan), the Geropon® brands (Rhodia), the Disponil® or Texapon® brands (Cognis) or the Rolpon® brands (Cesalpinia),

a3) disodium N-alkylsulfosuccinamate, commercially available, for example, in the form of the Aerosol® brands (Cytec), the Rewopol® or Rewoderm® brands (Rewo), the Empimin® brands (Albright&Wilson), the Geropon® brands (Rhodia) or the Polirol® brands (Cesalpinia),

a4) disodium fatty acid amide polyethylene glycol ether semisulfosuccinate, commercially available, for example, in the form of the Elfanol® or Lankropol® brands (Akzo Nobel), the Rewoderm®, Rewocid® or Rewopol® brands (Rewo), the Emcol® brands (Witco), the Standapol® brands (Cognis) or the Rolpon® brands (Cesalpinia), and

a5) tetrasodium N-(1,2-dicarboxyethyl)-N-octadecyl-sulfosuccinamate, commercially available, for example, in the form of Aerosol 22® (Cytec).

The active compounds from the group of the ALS inhibitors present in the formulations according to the invention are in particular sulfonamides, preferably from the group of the sulfonylureas, particularly preferably those of the formula (IV) and/or salts thereof:

R^{a}—SO₂—NR^{b}—CO—(NR^{c})ₓ—R^{d} (IV)

in which

R^{a} is a hydrocarbon radical, preferably an aryl radical, such as phenyl, which is unsubstituted or substituted, or a heterocyclic radical, preferably a heteroaryl radical, such as pyridyl, which is unsubstituted or substituted, where the radicals including substituents have 1-30 carbon atoms, preferably 1-20 carbon atoms, or R^{a} is an electron-withdrawing group, such as a sulfonamide radical,

R^{b} is a hydrogen atom or a hydrocarbon radical, which is unsubstituted or substituted and, including substituents, has 1-10 carbon atoms, for example unsubstituted or substituted C₁-C₆-alkyl, preferably a hydrogen atom or methyl,

R^{c} is a hydrogen atom or a hydrocarbon radical, which is unsubstituted or substituted and, including substituents, has 1-10 carbon atoms, for example unsubstituted or substituted C₁-C₆-alkyl, preferably a hydrogen atom or methyl,

x is zero or 1, and

R^{d} is a heterocyclyl radical.

For the purpose of this description, a hydrocarbon radical is a straight-chain, branched or cyclic, saturated or unsaturated aliphatic or aromatic hydrocarbon radical, for example alkyl, alkenyl, alkynyl, cycloalkyl, cycloalkenyl or aryl; aryl is a mono-, bi- or polycyclic aromatic system, for example phenyl, naphthyl, tetrahydronaphthyl, indenyl, indanyl, pentalenyl, fluorenyl and the like, preferably phenyl. A hydrocarbon radical has preferably 1 to 40 carbon atoms, more preferably 1 to 30 carbon atoms; particularly preferably, a hydrocarbon radical is alkyl, alkenyl or alkynyl having up to 12 carbon atoms or cycloalkyl having 3, 4, 5, 6 or 7 ring atoms or phenyl.

For the purpose of this description, a heterocyclic radical or ring (heterocyclyl) can be saturated, unsaturated or heteroaromatic and unsubstituted or substituted; it preferably contains one or more heteroatoms in the ring, preferably from the group consisting of N , O and S; it is preferably an aliphatic heterocyclyl radical having 3 to 7 ring atoms or a heteroaromatic radical having 5 or 6 ring atoms and contains 1, 2, or 3 heteroatoms. The heterocyclic radical can, for example, be a heteroaromatic radical or ring (heteroaryl), such as, for example, a mono-, bi- or polycyclic aromatic system in which at least 1 ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or is a partially or fully hydrogenated radical, such as oxiranyl, oxetanyl, pyrrolidyl, piperidyl, piperazinyl, dioxolanyl, morpholinyl, tetrahydrofuryl. Suitable substituents for a substituted heterocyclic radical are the substituents mentioned further below, and additionally also oxo. The oxo group may also be present at the hetero ring atoms, which may exist in different oxidation states, for example N and S.

For the purpose of this description, substituted radicals, such as substituted hydrocarbon radicals, for example substituted alkyl, alkenyl, alkynyl or aryl, such as phenyl or benzyl, or substituted heterocyclyl, are, for example, substituted radicals which are derived from an unsubstituted parent compound, where the substituents are, for example, one or more, preferably 1, 2, or 3, radicals from the group consisting of halogen (fluorine, chlorine, bromine, iodine), alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl, and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy etc. Among the radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)alkyl, preferably methyl or ethyl, (C₁-C₄)haloalkyl, preferably trifluoromethyl, (C₁-C₄)alkoxy, preferably methoxy or ethoxy, (C₁-C₄)haloalkoxy, nitro and cyano.

For the purpose of the present invention, the active compounds from the group of the ALS inhibitors which are present as component b) in the liquid formulations according to the invention, such as sulfonylureas, include, in addition to the neutral compounds, in each case also their salts with inorganic and/or organic counterions.

Suitable salts with inorganic counterions are, for example, salts with NH₄^{⊕}, SH₃^{⊕} or PH₄^{⊕} counterions or metal salts, for example with alkali metal or alkaline earth metal counterions. Suitable salts with organic counterions are, for example, organic ammonium, sulfonium and phosphonium salts. Preference is given to organic counterions of the formula [NR⁸R⁹R¹⁰R¹¹]⁺, [SR¹²R¹³R¹⁴]⁺ or [PR¹⁵R¹⁶R¹⁷R¹⁸]⁺, or to a quaternary pyridinium ion [Py-R¹⁹]⁺, where

R⁸, to R¹⁹ independently of one another are identical or different and are H or unsubstituted or substituted hydrocarbon radicals, such as unsubstituted or substituted (C₁-C₃₀)-alkyl, unsubstituted or substituted (C₁-C₁₀)-alkylaryl, unsubstituted or substituted (C₃-C₃₀)-(oligo)alkenyl, unsubstituted or substituted (C₃-C₁₀)-(oligo)alkenylaryl, unsubstituted or substituted (C₃-C₃₀)-(oligo)alkynyl, unsubstituted or substituted (C₃-C₁₀)-(oligo)alkynyl, aryl or unsubstituted or substituted aryl, or an unsubstituted or substituted heterocyclyl radical, in particular heteroaryl radical, such as unsubstituted or substituted (C₁-C₁₀)-alkyl-heteroaryl, unsubstituted or substituted (C₃-C₁₀)-(oligo)alkenyl-heteroaryl, unsubstituted or substituted (C₃-C₁₀)-(oligo)alkynyl-heteroaryl or unsubstituted or substituted heteroaryl, or two radicals R⁸/R⁹, R¹⁰/R¹¹, R¹²/R¹³, R¹⁵/R¹⁶ or R¹⁷/R¹⁸ together may form an unsubstituted or substituted ring, where at least one of the radicals R⁸-R¹¹, at least one of the radicals R¹²-R¹⁴ and at least one of the radicals R¹⁵-R¹⁸ is different from H.

Preferred ALS inhibitors originate from the group of the sulfonylureas, for example pyrimidine- or triazinylaminocarbonyl[benzene-, pyridine-, pyrazole-, thiophene- and (alkylsulfonyl)alkylamino]sulfamides. Preferred substituents on the pyrimidine ring or triazine ring are alkoxy, alkyl, haloalkoxy, haloalkyl, halogen or dimethylamino, where all substituents can be combined independently of one another. Preferred substituents in the benzene, pyridine, pyrazole, thiophene or (alkylsulfonyl)alkylamino moiety are alkyl, alkoxy, halogen, amino, alkylamino, dialkylamino, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, (alkanesulfonyl)alkylamino. Such suitable sulfonylureas are, for 5 example,

b1) phenyl- and benzylsulfonylureas and related compounds, for example

1-(2-chlorophenylsulfonyl)-3-(4-methoxy-6-methyl-1,3,5-triazin-2-yl)urea (chlorsulfuron),

1-(2-ethoxycarbonylphenylsulfonyl)-3-(4-chloro-6-methoxypyrimidin-2-yl)urea (chlorimuron-ethyl),

1-(2-methoxyphenylsulfonyl)-3-(4-methoxy-6-methyl-1,3,5-triazin-2-yl)urea (metsulfuron-methyl),

1-(2-chloroethoxyphenylsulfonyl)-3-(4-methoxy-6-methyl-1,3,5-triazin-2-yl)urea (triasulfuron),

1-(2-methoxycarbonylphenylsulfonyl)-3-(4,6-dimethylpyrimidin-2-yl)urea (sulfumeturon-methyl),

1-(2-methoxycarbonylphenylsulfonyl)-3-(4-methoxy-6-methyl-1,3,5-triazin-2-yl)-3-methylurea (tribenuron-methyl),

1-(2-methoxycarbonylbenzylsulfonyl)-3-(4,6-dimethoxypyrimidin-2-yl)urea (bensulfuron-methyl),

1-(2-methoxycarbonylphenylsulfonyl)-3-(4,6-bis(difluoromethoxy)pyrimidin-2-yl)urea (primisulfuron-methyl),

3-(4-ethyl-6-methoxy-1,3,5-triazin-2-yl)-1-(2,3-dihydro-1,1-dioxo-2-methylbenzo-[b]-thiophene-7-sulfonyl)urea (EP-A 0 796 83),

3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),

3-(4-methoxy-6-methyl-1,3,5-triazin-2-yl)-1-(2-methoxycarbonyl-5-iodophenyl-sulfonyl)urea (iodosulfuronmethyl and its sodium salt, WO 92/13845),

DPX-66037, triflusulfuron-methyl (see Brighton Crop Prot. Conf.—Weeds—1995, p. 853),

CGA-277476 (see Brighton Crop Prot. Conf.—Weeds—1995, p. 79), methyl 2-[3-(4,6-dimethoxypyrimidin-2-yl)ureidosulfonyl]-4-methanesulfonamido-methylbenzoate (mesosulfuron-methyl and its sodium salt, WO 95/10507), N,N-dimethyl-2-[3-(4,6-dimethoxypyrimidin-2-yl)ureidosulfonyl]-4-formylamino-benzamide (foramsulfuron and its sodium salt, WO 95/01344);

b2) thienylsulfonylureas, for example

1-(2-methoxycarbonylthiophen-3-yl)-3-(4-methoxy-6-methyl-1,3,5-triazin-2-yl)urea (thifensulfuron-methyl);

b3) pyrazolylsulfonylureas, for example

1-(4-ethoxycarbonyl-1-methylpyrazol-5-ylsulfonyl)-3-(4,6-dimethoxypyrimidin-2-yl)urea (pyrazosulfuron-methyl);

methyl 3-chloro-5-(4,6-dimethoxypyrimidin-2-ylcarbamoylsulfamoyl)-1-methyl-pyrazole-4-carboxylate (EP-A 0 282 613);

methyl 5-(4,6-dimethylpyrimidin-2-ylcarbamoylsulfamoyl)-1-(2-pyridyl)-pyrazole-4-carboxylate (NC-330, see Brighton Crop Prot. Conference “Weeds” 1991, Vol.1, p. 45 ff.),

DPX-A8947, azimsulfuron, (see Brighton Crop Prot. Conf. “Weeds” 1995, p. 65);

b4) sulfondiamide derivatives, for example

3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, special edition XII, 489-497 (1990));

b5) pyridylsulfonylureas, for example

1-(3-N,N-dimethylaminocarbonylpyridin-2-ylsulfonyl)-3-(4,6-dimethoxypyrimidin-2-yl)urea (nicosulfuron),

1-(3-ethylsulfonylpyridin-2-ylsulfonyl)-3-(4,6-dimethoxypyrimidin-2-yl)urea (rimsulfuron),

methyl 2-[3-(4,6-dimethoxypyrimidin-2-yl)ureidosulfonyl]-6-trifluoromethyl-3-pyridine-carboxylate, sodium salt (DPX-KE 459, flupyrsulfuron, see Brighton Crop Prot. Conf. Weeds, 1995, p. 49),

pyridylsulfonylureas, as described, for example, in DE-A 40 00 503 and DE-A 40 30 577, preferably those of the formula

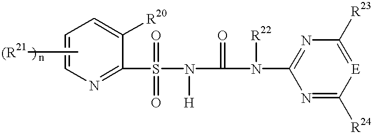

in which

E is CH or N, preferably CH,

R²⁰ is iodine or NR²⁵R²⁶,

R²¹ is hydrogen, halogen, cyano, (C₁-C₃)-alkyl, (C₁-C₃)-alkoxy, (C₁-C₃)-haloalkyl, (C₁-C₃)-haloalkoxy, (C₁-C₃)-alkylthio, (C₁-C₃)-alkoxy-(C₁-C₃)-alkyl, (C₁-C₃)-alkoxy-carbonyl, mono- or di-((C₁-C₃)-alkyl)amino, (C₁-C₃)-alkylsulfinyl or -sulfonyl, SO₂—NR^{x}R^{y} or CO—NR^{x}R^{y}, in particular hydrogen,

R^{x}, R^{y} independently of one another are hydrogen, (C₁-C₃)-alkyl, (C₁-C₃)-alkenyl, (C₁-C₃)-alkynyl or together are —(CH₂)₄—, —(CH₂)₅— or —(CH₂)₂—O—(CH₂)₂—,

n is 0, 1, 2 or 3, preferably 0 or 1,

R²² is hydrogen or CH₃,

R²³ is halogen, (C₁-C₂)-alkyl, (C₁-C₂)-alkoxy, (C₁-C₂)-haloalkyl, in particular CF₃, (C₁-C₂)-haloalkoxy, preferably OCHF₂ or OCH₂CF₃,

R²⁴ is (C₁-C₂)-alkyl, (C₁-C₂)-haloalkoxy, preferably OCHF₂, or (C₁-C₂)-alkoxy,

R²⁶ is (C₁-C₄)-alkyl,

R²⁵ (C₁-C₄)-alkylsulfonyl or

R²⁵ and R²⁶ together are a chain of the formula—(CH₂)₃SO₂— or —(CH₂)₄SO₂—, for example 3-(4,6-dimethoxypyrimidin-2-yl)-1-(3-N-methylsulfonyl-N-methyl-aminopyridin-2-yl)sulfonylurea, or salts thereof;

b6) alkoxyphenoxysulfonylureas, as described, for example, in EP-A 0 342 569, preferably those of the formula

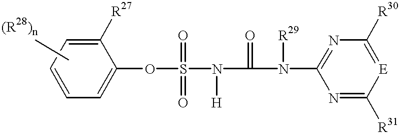

in which

E is CH or N, preferably CH,

R²⁷ is ethoxy, propoxy or isopropoxy,

R²⁸ is halogen, NO₂, CF₃, CN, (C₁-C₄)-alkyl, (C₁-C₄)-alkoxy, (C₁-C₄) -alkylthio or (C₁-C₃)-alkoxy-carbonyl, preferably in the 6-position on the phenyl ring,

n is 0, 1, 2 or 3, preferably 0 or 1,

R²⁹ is hydrogen, (C₁-C₄)-alkyl or (C₃-C₄)-alkenyl,

R³⁰, R³¹ independently of one another are halogen, (C₁-C₂)-alkyl, (C₁-C₂)-alkoxy, (C₁-C₂)-haloalkyl, (C₁-C₂)-haloalkoxy or (C₁-C₂)-alkoxy-(C₁-C₂)-alkyl, preferably OCH₃ or CH₃, for example 3-(4,6-dimethoxypyrimidin-2-yl)-1-(2-ethoxyphenoxy)sulfonylurea, or salts thereof;

b7) imidazolylsulfonylureas, for example

MON 37500, sulfosulfuron (see Brighton Crop Prot. Conf. “Weeds”, 1995, p. 57), and other related sulfonylurea derivatives and mixtures thereof.

Typical representatives of these active compounds are, inter alia, the compounds listed below: amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, iodosulfuron-methyl and its sodium salt (WO 92/13845), mesosulfuron-methyl and its sodium salt (Agrow No. 347, Mar. 3, 2000, page 22 (PJB Publications Ltd. 2000)) and foramsulfuron and its sodium salt.(Agrow No. 338, Oct. 15, 1999, page 26 (PJB Publications Ltd. 2000)).

The active compounds listed above are known, for example, from The Pesticide Manual, 12th edition (1999), The British Crop Protection Council, or the literature references listed after the individual active compounds.

If appropriate, the liquid formulations of the present invention may, in addition to components a) and b), comprise one or more auxiliaries and additives as further components, for example:

(c) additional surfactants and/or polymers,

(d) organic solvents,

(e) agrochemicals which are different from ALS inhibitors, such as herbicides, insecticides, fungicides, safeners, growth regulators or fertilizers,

(e) customary formulation auxiliaries, such as antifoams, evaporation inhibitors, odorants, colorants, antifreeze agents or preservatives,

(g) tank mix components, and/or

(h) additional water.

Thus, the liquid formulations of the present invention may comprise, as component c), for example one or more ionic or nonionic surfactants and/or polymers and/or one or more components based on silicone, such as, for example, trisiloxane surfactants, derivatives of polydimethylsiloxanes and/or silicone oils. Examples of preferred components c) are (poly)alkylene oxide adducts, in particular of fatty alcohols and/or fatty acids and/or components which are insoluble in the continuous phase. Examples of (poly)alkylene oxide adducts are Soprophor CY8® (Rhodia), Genapol X-060®, Genapol X-080® or Genagen MEE® (methyl ester ethoxylates) (Clariant) and other terminally-capped surfactants having a methyl, ethyl, n-propyl, isopropyl, n-butyl, tert-butyl, isobutyl, sec-butyl or acetyl group as terminal grouping. Components which are insoluble in the continuous phase and which can be used are, for example, anionic surfactants, such as Hostapur OSB® (Clariant), Netzer IS® (Clariant), Galoryl DT 201® (CFPI), Tamol® (BASF) or Morwet D 425® (Witco). By incorporating components which are insoluble in the continuous phase or else insoluble active compounds into the formulations, dispersions are obtained. Accordingly, the present invention also embraces dispersions.

Moreover, the liquid formulations according to the invention may also comprise, as component d), solvents, for example organic solvents, such as nonpolar solvents, polar protic or aprotic dipolar solvents and mixtures thereof. Examples of solvents are

aliphatic or aromatic hydrocarbons, for example mineral oils, paraffins or toluene, xylenes and naphthalene derivatives, in particular 1-methylnaphthalene, 2-methylnaphthalene, mixtures of C₆-C₁₆-aromatic compounds, such as the Solvesso® group (ESSO), for example with the types Solvesso® 100 (b.p. 162-177° C.), Solvesso® 150 (b.p. 187-207° C.) and Solvesso® 200 (b.p. 219-282° C.) and C₆-C₂₀-aliphatic compounds, which may be linear or cyclic, such as the products of the Shellsol® group, types T and K, or BP-n paraffins,

halogenated aliphatic or aromatic hydrocarbons, such as methylene chloride or chlorobenzene,

esters such as triacetin (acetic acid triglyceride), butyrolactone, propylene carbonate, triethyl citrate and (C₁-C₂₂)alkyl phthalates, especially (C₁-C₈)alkyl phthalates, (C₁-C₁₃)alkyl maleates,

alcohols, such as methanol, ethanol, n- and isopropanol, n-, iso-, t-, 2-butanol, tetrahydrofurfuryl alcohol,

ethers, such as diethyl ether, tetrahydrofuran (THF), dioxane, alkylene glycol monoalkyl ethers and dialkyl ethers, such as, for example, propylene glycol monomethyl ether, especially Dowanol® PM (propylene glycol monomethyl ether), propylene glycol monoethyl ether, ethylene glycol monomethyl ether or monoethyl ether, diglyme and tetraglyme,

amides, such as dimethylformamide (DMF), dimethylacetamide, dimethylcaprylamide/dimethylcaprinamide and N-alkylpyrrolidones,

ketones, such as the water-soluble acetone, but also water-imiscible ketones, such as, for example, cyclohexanone or isophorone,

nitriles, such as acetonitrile, propionitrile, butyronitrile and benzonitrile,

sulfoxides and sulfones, such as dimethyl sulfoxide (DMSO) and sulfolane, and also

oils in general, such as mineral oils or vegetable oils, such as corn oil, linseed oil and rapeseed oil.

Organic solvents which are preferred for the purpose of the present invention are ester oils, such as rapeseed oil methyl ester, tetrahydrofurfuryl alcohol or triacetin.

In addition to the ALS inhibitors which are present as component b), the liquid formulations according to the invention may, as component e), comprise further agrochemicals which are different from ALS inhibitors. This applies, for example, to combinations of herbicides different from ALS inhibitors, for example from the group of the phenoxyphenoxypropionates, such as diclofop-methyl, of the group of the heteroaryloxyphenoxypropionates, such as fenoxaprop-ethyl or clodinafoppropargyl, or from the group of the alkylazines, or else for combinations with safeners.

Herbicides which are different from ALS inhibitors are, for example, herbicides from the group of the carbamates, thiocarbamates, haloacetanilides, substituted phenoxy-,naphthoxy- and phenoxyphenoxycarboxylic acid derivatives and also heteroaryloxyphenoxyalkanecarboxylic acid derivatives, such as quinolyloxy-, quinoxalyloxy-, pyridyloxy-, benzoxazolyloxy- and benzthiazolyloxyphenoxyalkanecarboxylic esters, cyclohexanedione derivatives, imidazolinones, pyrimidinyloxypyridinecarboxylic acid derivatives, pyrimidyloxybenzoic acid derivatives, triazolopyrimidinesulfonamide derivatives and also S-(N-aryl-N-alkylcarbamoylmethyl) dithiophosphoric esters. Preference is given here to phenoxyphenoxy- and heteroaryloxyphenoxycarboxylic acid esters and salts, to imidazolinones and to herbicides which are used together with ALS inhibitors (acetolactate synthetase inhibitors) for widening the activity spectrum, for example betazone, cyanazine, atrazine, dicamba or hydroxybenzonitriles such as bromoxynil and ioxynil and other foliar herbicides.

suitable herbicides which may be present in the formulations according to the invention as component e) are, for example:

A) herbicides of the type of the phenoxyphenoxy- and heteroaryloxyphenoxycarboxylic acid derivatives, such as

A1) phenoxyphenoxy- and benzyloxyphenoxycarboxylic acid derivatives, for example methyl 2-(4-(2,4-dichlorophenoxy)phenoxy)propionates (diclofop-methyl), methyl 2-(4-(4-bromo-2-chlorophenoxy)phenoxy)propionate (DE-A 26 01 548), methyl 2-(4-(4-bromo-2-fluorophenoxy)phenoxy)propionate (U.S. Pat. No. 4,808,750), methyl 2-(4-(2-chloro-4-trifluoromethylphenoxy)phenoxy)propionate (DE-A 24 33 067), methyl 2-(4-(2-fluoro-4-trifluoromethylphenoxy)phenoxy)propionate (U.S. Pat. No. 4,808,750), methyl 2-(4-(2,4-dichlorobenzyl)phenoxy)propionate (DE-A 24 17 487), ethyl 4-(4-(4-trifluoromethylphenoxy)phenoxy)pent-2-enoate, methyl 2-(4-(4-trifluoromethylphenoxy)phenoxy)propionate (DE-A 24 33 067);

A2) “Monocyclic” heteroaryloxyphenoxyalkanecarboxylic acid derivatives, for example ethyl 2-(4-(3,5-dichloropyridyl-2-oxy)phenoxy)propionate (EP-A 0 002 925), propargyl 2-(4-(3,5-dichloropyridyl-2-oxy)phenoxy)propionate (EP-A 0 003 114), methyl 2-(4-(3-chloro-5-trifluoromethyl-2-pyridyloxy)phenoxy)propionate (EP-A 0 003 890), ethyl 2-(4-(3-chloro-5-trifluoromethyl-2-pyridyloxy)phenoxy)propionate (EP-A 0 003 890), propargyl 2-(4-(5-chloro-3-fluoro-2-pyridyloxy)phenoxy)propionate (EP-A 0 191 736), butyl 2-(4-(5-trifluoromethyl-2-pyridyloxy)phenoxy)propionate (fluazifop-butyl);

A3) “Bicyclic” heteroaryloxyphenoxyalkanecarboxylic acid derivatives, for example methyl and ethyl 2-(4-(6-chloro-2-quinoxalyloxy)phenoxy)propionate (quizalofopmethyl and quizalofopethyl), methyl 2-(4-(6-fluoro-2-quinoxalyloxy)phenoxy)propionate (see J. Pest. Sci. Vol.10, 61 (1985)), 2-isopropylidenaminooxyethyl 2-(4-(6-chloro-2-quinoxalyloxy)phenoxy)propionate (propaquizafop), Ethyl 2-(4-(6-chlorobenzoxazol-2-yloxy)phenoxy)propionate (fenoxaprop-ethyl), its D(+) isomer (fenoxaprop-P-ethyl) and ethyl 2-(4-(6-chlorobenzothiazol-2-yloxy)phenoxy)propionate (DE-A 26 40 730), tetrahydro-2-furylmethyl 2-(4-(6-chloroquinoxalyloxy)phenoxy)propionate (EP-A 0 323 727);

B) Chloroacetanilides, for example N-methoxymethyl-2,6-diethyl-chloroacetanilide (alachlorine), N-(3-methoxyprop-2-yl)-2-methyl-6-ethylchloroacetanilide (metolachlor), 2,6-dimethyl-N-(3-methyl-1,2,4-oxadiazol-5-ylmethyl)chloroacetanilide, N-(2,6-dimethylphenyl)-N-(1-pyrazolylmethyl)chloroacetamide (metazachlor);

C) Thiocarbamates, for example S-ethyl N,N-dipropylthiocarbamate (EPTC), S-ethyl N,N-diisobutylthiocarbamate (butylate);

D) Cyclohexanedione oximes, for example methyl 3-(1-allyloxyiminobutyl)-4-hydroxy-6,6-dimethyl-2-oxocyclohex-3-enecarboxylate, (alloxydim), 2-(1-ethoxyiminobutyl)-5-(2-ethylthiopropyl)-3-hydroxycyclohex-2-ene-1-one (sethoxydim), 2-(1-ethoxyiminobutyl)-5-(2-phenylthiopropyl)-3-hydroxycyclohex-2-ene-1-one (cloproxydim), 2-(1-(3-chloroallyloxy)iminobutyl)-5-(2-ethylthiopropyl)-3-hydroxycyclohex-2-ene-1-one, 2-(1-(3-chloroallyloxy)iminopropyl)-5-(2-ethylthiopropyl)-3-hydroxycyclohex-2-ene-1-one (clethodim), 2-(1-ethoxyiminobutyl)-3-hydroxy-5-(thian-3-yl)cyclohex-2-enone (cycloxydim), 2-(1-ethoxyiminopropyl)-5-(2,4,6-trimethylphenyl)-3-hydroxycyclohex-2-ene-1-one (tralkoxydim);

E) Imidazolinones, for example methyl 2-(4-isopropyl-4-methyl-5-oxo-2-imidazolin-2-yl)-5-methylbenzoate and 2-(4-isopropyl-4-methyl-5-oxo-2-imidazolin-2-yl)-4-methylbenzoic acid (imazamethabenz), 5-Ethyl-2-(4-isopropyl-4-methyl-5-oxo-2-imidazolin-2-yl)-pyridine-3-carboxylic acid (imazethapyr), 2-(4-isopropyl-4-methyl-5-oxo-2-imidazolin-2-yl)quinoline-3-carboxylic acid (imazaquin), 2-(4-isopropyl-4-methyl-5-oxo-2-imidazolin-2-yl)pyridine-3-carboxylic acid (imazapyr), 5-methyl-2-(4-isopropyl-4-methyl-5-oxo-2-imidazolin-2-yl)pyridine-3-carboxylic acid (imazethamethapyr);

F) Triazolopyrimidinesulfonamide derivatives, for example N-(2,6-difluorophenyl)-7-methyl-1,2,4-triazolo[1,5-c]pyrimidine-2-sulfonamide (flumetsulam), N-(2,6-dichloro-3-methylphenyl)-5,7-dimethoxy-1,2,4-triazolo[1,5-c]pyrimidine-2-sulfonamide, N-(2,6-difluorophenyl)-7-fluoro-5-methoxy-1,2,4-triazolo[1,5-c]pyrimidine-2-sulfonamide, N-(2,6-dichloro-3-methylphenyl)-7-chloro-5-methoxy-1,2,4-triazolo[1,5-c]pyrimidine-2-sulfonamide, N-(2-chloro-6-methoxycarbonyl)-5,7-dimethyl-1,2,4-triazolo[1,5-c] pyrimidine-2-sulfonamide (EP-A 0 343 752, U.S. Pat. No. 4,988,812);

G) Benzoylcyclohexanediones, for example 2-(2-chloro-4-methylsulfonylbenzoyl)cyclohexano-1,3-dione (SC-0051, EP-A 0 137 963), 2-(2-nitrobenzoyl)-4,4-dimethylcyclohexane-1,3-dione (EP-A 0 274 634), 2-(2-nitro-3-methylsulfonylbenzoyl)-4,4-dimethylcyclohexane-1,3-dione (WO 91/13548);

H) Pyrimidinyloxypyridine carboxylic acid derivatives or pyrimidinyloxybenzoic acid derivatives, for example benzyl 3-(4,6-dimethoxypyrimidin-2-yl)oxypyridine-2-carboxylate (EP-A-0 249 707), methyl 3-(4,6-dimethoxypyrimidin-2-yl)oxypyridine-2-carboxylate (EP-A-0 249 707), 2,6-bis[(4,6-dimethoxypyrimidin-2-yl)oxy]benzoic acid (EP-A 0 321 846), 1-(ethoxycarbonyloxyethyl) 2,6-bis[(4,6-dimethoxypyrimidin-2-yl)-oxy]benzoate (EP-A 0 472 113);

I) S-(N-Aryl-N-alkylcarbamoylmethyl) dithiophosphonates, such as S-[N-(4-chlorophenyl)-N-isopropylcarbamoylmethyl] O,O-dimethyl dithiophosphate (anilophos);

J) Alkylazines, such as, for example, described in WO-A 97/08156, WO-A-97/31904, DE-A-19826670, WO-A-98/15536, WO-A-8/15537, WO-A-98/15538, WO-A-98/15539 and also DE-A-19828519, WO-A-98/34925, WO-A-98/42684, WO-A-99/18100, WO-A-99/19309, WO-A-99/37627 and WO-A-99/65882, preferably those of the formula (E)

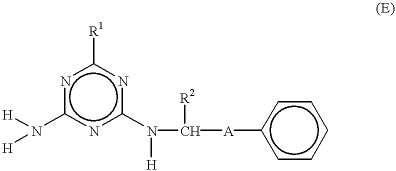

in which

R¹, is (C₁-C₄)-alkyl or (C₁-C₄)-haloalkyl;

R² is (C₁-C₄)-alkyl, (C₃-C₆)-cycloalkyl or (C₃-C₆)-cycloalkyl-(C₁-C₄)-alkyl and

A is —CH₂—, —CH₂—CH₂—, —CH₂—CH₂—CH₂—, —O—, —CH₂—CH₂—O—, —CH₂—CH₂—CH₂—O—, particularly preferably those of the formulae E1-E7

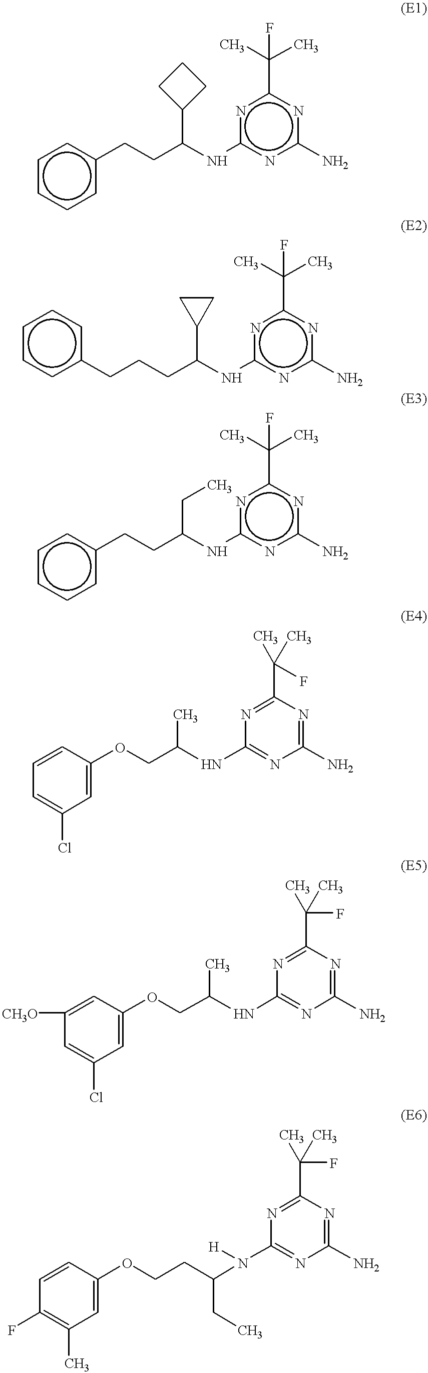

The herbicides of groups A to J are known, for example, from the abovementioned publications and from “The Pesticide Manual”, The British Crop Protection Council and the Royal Soc. of Chemistry, 10th Edition, 1994, “Agricultural Chemicals Book II—Herbicides—”, by W. T. Thompson, Thompson Publications, Fresno Calif., USA 1990 and “Farm Chemicals Handbook '90”, Meister Publishing Company, Willoughby Ohio, USA, 1990.

The following groups of compounds may, for example, be present as safeners in the formulations according to the invention:

a) compounds of the type of dichlorophenylpyrazoline-3-carboxylic acid (S1), preferably compounds such as ethyl 1-(2,4-dichlorophenyl)-5-(ethoxycarbonyl)-5-methyl-2-pyrazoline-3-carboxylate (S1-1), and related compounds, as described in WO 91/07874,

b) derivatives of dichlorophenylpyrazole carboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds as described in EP-A-333 131 and EP-A-269 806,

c) Compounds of the type of the triazolecarboxylic acids (S1), preferably compounds such as fenchlorazole, i.e. ethyl 1-(2,4-dichlorophenyl)-5-trichloromethyl-(1H)-1,2,4-triazole-3-carboxylate (S1-6) and related compounds (see EP-A-174 562 and EP-A-346 620);

d) compounds of the type of the 5-benzyl- or 5-phenyl-2-isoxazoline-3-carboxylic acid, or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91108202, or ethyl 5,5-diphenyl-2-isoxazolinecarboxylate (S1-9) or n-propyl ester (S1-10) or ethyl 5-(4-fluorophenyl)-5-phenyl-2-isoxazoline-3-carboxylate (S1-11), as described in the German patent application (WO-A-95/07897),

e) Compounds of the type of the 8-quinolineoxyacetic acid (S2), preferably 1-methylhex-1-yl(5-chloro-8-quinolineoxy)acetate (S2-1) 1,3-dimethylbut-1-yl(5-chloro-8-quinolineoxy)acetate (S2-2), 4-allyloxybutyl (5- chloro-8-quinolineoxy)acetate (S2-3), 1-allyloxyprop-2-yl(5-chloro-8-quinolineoxy)acetate (S2-4), ethyl (5-chloro-8-quinolineoxy)acetate (S2-5), methyl (5-chloro-8-quinolineoxy)acetate (2-6), allyl (5-chloro-8-quinolineoxy)acetate (S2-7), 2-(2-propylideneiminoxy)-1-ethyl (5-chloro-8-quinolineoxy)acetate (S2-8), 2-oxoprop-1-yl (5-chloro -8-quinolineoxy )acetate (S2-9) and related compounds, as described in EP-A-86 750, EP-A-94 349 and EP-A-191 736 or EP-A-0 492 366,

f) compounds of the type of the (5-chloro-8-quinolineoxy)malonic acid, preferably compounds such as diethyl (5-chloro-8-quinolineoxy)malonate, diallyl (5-chloro-8-quinolineoxy)malonate, methyl ethyl (5-chloro-8-quinoline-oxy)malonate and related compounds, as described in EP-A-0 582 198,

g) active compounds of the type of the phenoxyacetic or -propionic acid derivatives or the aromatic carboxylic acids, such as, for example, 2,4-dichlorophenoxyacetic acid (esters) (2,4-D), 4-chloro-2-methylphenoxypropionic esters (mecoprop), MCPA or 3,6-dichloro-2-methoxybenzoic acid (esters) (dicamba),

h) active compounds of the type of the pyrimidines, which are used as soil-acting safeners in rice, such as, for example, “fenclorim” (PM, pp. 511-512) (=4,6-dichloro-2-phenylpyrimidine), which is known as safener for pretilachlor in sown rice,

i) active compounds of the type of the dichloroacetamides, which are frequently used as pre-emergent safeners (soil-acting safeners), such as, for example, “dichlormid” (PM, pp. 363-364) (=N,N-diallyl-2,2-dichloroacetamide), “R-29148” (=3-dichloroacetyl-2,2,5-trimethyl-1,3-oxazolidine from Stauffer), “benoxacor” (PM, pp.102-103) (=4-dichloroacetyl-3,4-dihydro-3-methyl-2H-1,4-benzoxazine), “PPG-1292” (=N-allyl-N-[(1,3-dioxolan-2-yl)methyl]dichloroacetamide from PPG Industries), “DK-24” (=N-allyl-N-[(allylaminocarbonyl)methyl]dichloroacetamide from Sagro-Chem), “AD-67” or “MON 4660” (=3-dichloroacetyl-1-oxa-3-aza-spiro[4,5]decane from Nitrokemia or Monsanto), “diclonon” or “BAS145138” or “LAB145138” (=3dichloroacetyl-2,5,5-trimethyl-1,3-diazabicyclo[4.3.0]nonane from BASF) and “furilazol” or “MON 13900” (see PM, 637-638) (=(RS)-3-dichloroacetyl-5-(2-furyl)-2,2-dimethyloxazolidine),

j) active compounds of the type of the dichloroacetone derivatives, such as, for example, “MG 191” (CAS-Reg. No. 96420-72-3) (=2-dichloromethyl-2-methyl-1,3-dioxolane from Nitrokemia), which is known as safener for corn,

k) active compounds of the type of the oxyimino compounds, which are known as seed dressings, such as, for example, “oxabetrinil” (PM, pp. 902-903) (=(Z)-1,3-dioxolan-2-ylmethoxy-imino(phenyl)acetonitrile), which is known as seed dressing safener against metolachlor damage, “fluxofenim” (PM, pp. 613-614) (=1-(4-chlorophenyl)-2,2,2-trifluoro-1-ethanone O-(1,3-dioxolan-2-ylmethyl) oxime), which is known as seed dressing safener against metolachlor damage, and “cyometrinil” or “-CGA-43089” (PM, p. 1304) (=(Z)-cyanomethoxyimino(phenyl)acetonitrile), which is known as seed dressing safener against metolachlor damage,

l) active compounds of the type of the thiazolecarboxylic esters, which are known as seed dressings, such as, for example, “flurazol” (PM, pp. 590-591) (=benzyl 2-chloro-4-trifluoromethyl-1,3-thiazole-5-carboxylate), which is known as seed dressing safener against alachlor and metolachlor damage,

m) active compounds of the type of the naphthalenedicarboxylic acid derivatives, which are known as seed dressings, such as, for example, “naphthalic anhydride” (PM, p. 1342) (=1,8-naphthalenedicarboxylic anhydride), which is known as seed dressing safener for corn against thiocarbamate herbicide damage,

n) active compounds of the type of the chromanacetic acid derivatives, such as, for example, “CL 304415” (CAS-Reg. No. 31541-57-8) (=2-84-carboxychroman-4-yl)acetic acid from American Cyanamid), which is known as safener for corn against imidazolinone damage,

o) active compounds which, in addition to a herbidical action against harmful plants, also have safener action in crop plants such as rice, such as, for example, “dimepiperate” or “MY-93” (PM, pp. 404-405) (=S-1-methyl-1-phenylethyl piperidine-1-thiocarboxylate), which is known as safener for rice against damage by the herbicide molinate, “daimuron” or “SK 23” (PM, p. 330) (=1-(1-methyl-1-phenylethyl)-3-p-tolylurea), which is known as safener for rice against damage by the herbicide imazosulfuron, “cumyluron” =“JC-940” (=3-(2-chlorophenylmethyl)-1-(1-methyl-1-phenylethyl)urea, see JP-A-60087254), which is known as safener for rice against damage by some herbicides, “methoxyphenon” or “NK 049” (=3,3′-dimethyl-4-methoxybenzophenone), which is known as safener for rice against damage by some herbicides, “CSB” (=1-bromo4-(chloromethylsulfonyl)benzene) (CAS-Reg. No. 54091-06-4 from Kumiai)

In the liquid formulations according to the invention, customary formulation auxiliaries, such as antifoams, antifreeze agents, evaporation inhibitors, preservatives, odorants or colorants may be present as component f). Preferred formulation auxiliaries are antifreeze agents and evaporation inhibitors such as glycerol, for example in an amount of from 2 to 10% by weight, and preservatives, for example Mergal K9N® (Riedel) or Cobate C®.

The formulations according to the invention may also, as component g), comprise tank mix components. Examples of these are tank mix adjuvants, such as Telmion® (Hoechst) or esterified vegetable oils such as Actirob B® (Novance) or Hasten® (Victorian Chemicals), inorganic compounds such as ammonium sulfate, ammonium nitrate and fertilizers or hydrotropics.

The formulations according to the invention may also comprise, as component h), additional water. Particular preference is given to liquid formulations according to the invention which, as component a), comprise a sodium dialkylsulfosuccinate such as Triton® and, as component b), one or more sulfonylureas from the group consisting of iodosulfuron-methyl, mesosulfuron-methyl, foramsulfuron, ethoxysulfuron or amidosulfuron and/or salts thereof, for example alkali metal salts, such as sodium salts, or ammonium salts, in particular quaternary ammonium salts, such as tetrabutyl ammonium salts. These particularly preferred formulations may additionally, as component e), comprise one or more agrochemically active compounds from the group consisting of fenoxaprop-ethyl, diflufenican, mefenpyr-diethyl and isoxadifen-ethyl.

Liquid formulations according to the invention can be present, for example, in the form of solutions, emulsion concentrates or dispersions, such as emulsions or suspensions. Here, preferably at least one active compound from the group of the ALS inhibitors, preferably at least one sulfonylurea, is present in dissolved form. In a particularly preferred embodiment, all active compound ingredients are dissolved.

It is possible to convert the virtually water-free solutions according to the invention by addition of water into microemulsions, macroemulsions or water-containing solutions. Thus, in addition to virtually water-free solutions (for example in organic solvents or in the derivatives of polycarboxylic acids obtained according to the invention), the present invention also embraces water-containing formulations such as O/W and W/O microemulsions or EW and EO macroemulsions.

By incorporating active compounds or components which are insoluble in the continuous phase into the formulations, suspensions are obtained. Accordingly, the present invention also embraces such suspensions.

On dilution with water, the formulations according to the invention give dispersions or else water-containing solutions, which are likewise embraced by the present invention.

The content of active compound in the formulations according to the invention is generally between 0.001% by weight and 50% by weight, higher loads being possible in individual cases, in particular when a plurality of active compounds is used. Since ALS inhibitors are highly effective active compounds, the preferred application rates are usually between 1 and 50 g of a.i./ha, i.e. even these extremely low application rates result in a massive intervention in the amino acid metabolism of the harmful plants, and the enzyme acetolactate synthase is inhibited, which in turn results in the death of the harmful plants. In general, the content of polycarboxylic acid derivatives is 0.1-80%; however, this may be higher in individual cases.

The auxiliaries and additives which can be used for preparing the formulations according to the invention, such as, for example, surfactants and solvents, are known in principle and are described, for example, in: McCutcheon's “Detergents and Emulsifiers Annual”, MC Publ. Corp., Ridgewood N.J.; Sisley and Wood, “Encyclopedia of Surface Active Agents”, Chem. Publ.Co.lnc., N.Y. 1964; Schönfeldt, “Grenzflächenaktive Äthylenoxidaddukte” [Surface-Active Ethylene Oxide Adducts], Wiss. Verlagsgesellschaft, Stuttgart 1976; Winnacker-Küchler, “Chemische Technologie” [Chemical Technology], volume 7, C. Hauser-Verlag, Munich, 4th edition 1986.

Preferred ratios of the components a):b) in the liquid formulations according to the invention, in particular in emulsion concentrates, are 1:0.1-1:100, preferably 1:1 to 1:20, for example about 1:2, 1:3, 1:5, 1:6, 1:7 or 1:10.

Liquid formulations according to the invention can be prepared by customary known processes, i.e., for example, by mixing the different components with the aid of stirrers, shakers or (static) mixers. If appropriate, brief heating may be advantageous. In the case of salt-like ALS inhibitors, this simple process makes it possible to prepare the corresponding ALS inhibitor salts in situ by using, for example, nonionic surfactants in which the catalyst—generally a metal catalyst—has not been subsequently neutralized. Thus, the present invention also embraces the processes described for preparing the liquid formulations according to the invention. These processes are distinguished in particular by production-related advantages.

In a preferred embodiment, the ALS inhibitors used, such as sulfonylureas, are inhibitors with counterions having phase-transfer properties. Such counterions are, for example, organic counterions, such as organic ammonium, sulfonium or phosphonium ions. Such counterions can be incorporated in a particularly simple manner into the formulations if they are present in admixture with additional, for example nonionic, formulation components. Accordingly, the invention also embraces the incorporation of the counterions into the formulations.

The liquid formulations according to the invention preferably comprise

(a) from 0.1 to 80% by weight, preferably from 10 to 60% by weight, of derivatives of polycarboxylic acids, in particular one or more compounds from the group of the gemini surfactants and/or sulfosuccinates,

(b) from 0.001 to 50% by weight, preferably from 1 to 15% by weight, of herbicidally active compound from the group of the ALS inhibitors, preferably from the group of the sulfonylureas,

(c) from 0 to 60% by weight, preferably from 0.1 to 50% by weight, of further surfactants and/or polymers,

(d) from 0 to 90% by weight, preferably from 1 to 30% by weight, of organic solvents.

(e) from 0 to 50% by weight, preferably from 0 to 30% by weight, of agrochemicals which are different from ALS inhibitors,

(f) from 0 to 20% by weight, preferably from 0 to 10% by weight, of customary formulation auxiliaries, and

(h) from 0 to 50% by weight, preferably from 0 to 10% by weight, of additional water.

Particularly preferred formulations according to the invention are water-free emulsion concentrates, comprising

(a) from 10 to 60% by weight of derivatives of polycarboxylic acids, in particular one or more compounds from the group of the gemini surfactants and/or sulfosuccinates,

(b) from 1 to 15% by weight of herbicidally active compounds of the type of the ALS inhibitors, in particular from the group of the sulfonylureas,

(c) from 0 to 50% by weight of further surfactants and/or polymers,

(d) from 0 to 30% by weight of organic solvents,

(e) from 0 to 50% by weight of agrochemicals which are different from ALS inhibitors and

(f) from 0 to 10% by weight of customary formulation auxiliaries.

The liquid formulations according to the invention can be used, for example, for controlling undesirable vegetation. To this end, an effective amount of the formulation according to the invention is, if required after dilution with water, applied to the seeds, plants, parts of plants or the area under cultivation.

The formulations according to the invention are formulations which are physically and chemically stable and which, on dilution with water, give spray liquors having favorable physical performance characteristics. In addition, the formulations according to the invention have favorable biological properties and can be used widely, for example for controlling undesirable vegetation.

### EXAMPLES

The stated amounts of the components listed in Table 1 were mixed with one another and, in the case of Examples XII to XIV, subsequently ground. The initial values and final values (g of sulfonylurea in the formulation) were determined by HPLC. In Examples I-XI and XV, emulsion concentrates were obtained; in Examples XII-XIV, dispersions were obtained. The examples show that derivatives of polycarboxylic acids, in particular of the type of the sulfosuccinates, have a stabilizing effect on liquid sulfonylurea formulations. The formulations according to the invention may also comprise solvents (Examples IV-VII), commercial adjuvants (Examples X and XI), nonionic surfactants (Example IX) or dispersed surfactant components (Examples XII, XIII and XIV). In addition to stable “one-active-compound formulations”, the formulations according to the invention may also be formulations comprising two, three or more active compounds.

In Table 1, the given numbers refer to the weight in grams.

Abbreviations for Table 1

| | |
|---|---|
| NBu₄ | tetrabutylammonium |
| Na | sodium |
| NaDOS | sodium di(ethylhexyl)sulfosuccinate |
| THF-alcohol | tetrahydrofurfuryl alcohol |
| Eumulgin CO 3522 ® | rapeseed oil ethoxylate (Cognis GmbH) |
| E1 | 2-amino-4-(1 -fluoro-1-methylethyl)-6-(3-phenyl- |
| | 1-cyclobutyl-1-propylamino)-1,3,5-triazine |

TABLE 1
Formulation examples of liquid formulations according to the invention

| | I | II | III | IV | V | VI | VII | VIII | IX | X | XI | XII | XIII | XIV | XV |
|---|---|---|---|---|---|---|---|---|---|---|---|---|---|---|---|
| foramsulfuron · NBu₄ | 6.22 | | | | | | | | | | | | | | |
| mesosulfuron · Na | | 8.39 | | | | | | | | | | | | | |
| iodosulfuron | | | 7.46 | 7.47 | 3.72 | 10.18 | 6.31 | 4.65 | 4.61 | 7.44 | 7.45 | 13.16 | 13.68 | 13.94 | 1.54 |
| E1 | | | | | | | | | | | | | | | 8.02 |
| fenoxaprop-ethyl | | | | | | | | 7.94 | 8.01 | | | | | | |
| mefenpyr-diethyl | | | | | | | | 3.05 | 3.08 | | | | | | 4.46 |
| Triton GR 7 ME ® | 93.78 | 69.95 | 81.98 | 82.04 | 31.0 | 49.75 | 90.69 | 84.36 | | 82.59 | 82.67 | 82.10 | 78.95 | 79.81 | 15.00 |
| Na-DOS | | | | | | | | | 24.99 | | | | | | |
| THF alcohol | | 21.66 | | | | | | | | | | | | | |
| propylene carbonate | | | 10.56 | | | | | | | | | | | | |
| tributyl phosphate | | | | 10.49 | | | | | | | | | | | |
| Edenor MESU ® | | | | | 65.28 | | | | 39.52 | | | | | | 3.00 |
| Solvesso 200 ® | | | | | | 40.07 | | | | | | | | | 58.47 |
| H₂O | | | | | | | 3.0 | | | | | | | | |
| Eumulgin CO 3522 ® | | | | | | | | | | | | | | | 9.51 |
| Soprophor CY8 ® | | | | | | | | | 19.79 | | | | | | |
| Actirob B ® (including | | | | | | | | | | 9.97 | | | | | |
| emulsifier) | | | | | | | | | | | | | | | |
| Hasten ® | | | | | | | | | | | 9.88 | | | | |
| Netzer IS ® | | | | | | | | | | | | 4.74 | | | |
| Morwet D425 ® | | | | | | | | | | | | | 7.37 | | |
| Hostapur OSB ® | | | | | | | | | | | | | | 6.25 | |
| initial value | 6.17 | 8.36 | 7.32 | 7.38 | 3.04 | 10.3 | 6.11 | 4.31 | 3.14 | 7.23 | 6.70 | 13.50 | 14.20 | 14.20 | 1.43 |
| (sulfonylurea) | | | | | | | | | | | | | | | |
| final value | 6.12 | 8.10 | 7.31 | 7.22 | 2.90 | 9.84 | 5.85 | 4.17 | 3.07 | 7.09 | 6.66 | 13.20 | 14.10 | 13.50 | 1.33 |
| (sulfonylurea), i.e. | | | | | | | | | | | | | | | |
| after storage at | | | | | | | | | | | | | | | |
| T = 54° C., 14 days | | | | | | | | | | | | | | | |

### COMPARATIVE EXAMPLES

The stated amounts of iodosulfuron, fenoxaprop-ethyl, mefenpyr-diethyl and propylene carbonate were mixed. The initial values and final values (g of iodosulfuron in the formulation) were determined by HPLC. What is obtained is not a stable formulation but a system which is unstable on storage as is evident from Table 2 (Example 1). If a surfactant component such as Genapol X-060® is added, the storage stability is reduced even further (Example 2).

In Table 2, the stated numbers refer to the weight in grams.

TABLE 2
Examples of liquid formulations in which the active compound is
degraded during storage

| | 1 | 2 |
|---|---|---|
| iodosulfuron | 1.40 | 1.40 |
| fenoxaprop-ethyl | 11.08 | 11.08 |
| mefenpyr-diethyl | 4.17 | 4.17 |
| propylene carbonate | 83.35 | 73.35 |
| Genapol X-060 ® | | 10.0 |
| initial value Ciodosulfuron) | 1.29 | 1.35 |
| final value (iodosulfuron), | 0.32 | <0.05 |
| i.e. after storage at | | |
| T = 54° C., 14 days | | |

1. A liquid formulation, comprising a) one or more derivatives of polycarboxylic acids and b) one or more active compounds from the group of the ALS inhibitors.

2. The liquid formulation as claimed in claim 1, which comprises, as component a), one or more compounds from the group of the gemini surfactants and/or sulfosuccinates.

3. The liquid formulation as claimed in claim 1, which comprises, as component b), one or more sulfonylureas.

4. The liquid formulation as claimed in claim 1, which comprises, as component a), one or more compounds from the group of the gemini surfactants of the formula
(II) R⁵—CO—NA—R⁶—NB—CO—R⁷ or
(III) R⁵—O—CO—CH(SO³M )—R⁶—CH (SO³M)—CO—O—R⁷, in which
R⁵,R⁷ independently of one another are identical or different and are branched or straight-chain saturated or unsaturated hydrocarbon radicals having 1 to 30 carbon atoms,
R⁶ is a spacer of a straight-chain or branched chain having 2 to 100 carbon atoms which contains 0 to 20 oxygen atoms, 0 to 4 sulfur atoms and/or 0 to 3 phosphorus atoms and which has 0 to 20 functional side groups and which contains 0 to 100 alkoxy groups,
A,B independently of one another are identical or different and are polyalkylene oxide radicals having a terminal OH, C₁-C₂₀-alkyl, carboxyethyl, carboxymethyl, sulfonic acid, sulfuric acid, phosphoric acid or betaine grouping, and
M is a cation.

5. The liquid formulation as claimed in claim 1 which comprises, as component a), one or more compounds from the group of the sulfosuccinates of the formula (I) R¹—X—CO—CH₂—CH(SO₃R³)—CO—Y—R²)in which
R¹,R² independently of one another are identical or different and are H, substituted or unsubstituted C₁-C₃₀-hydrocarbon radicals or (poly)alkylene oxide adducts,
R³ is a cation and
X,Y independently of one another are identical or different and are O or NR⁴, where R⁴ is H, a substituted or unsubstituted C₁-C₃₀-hydrocarbon radical, dicarboxyethyl or a (poly)alkylene oxide adduct.

6. The liquid formulation as claimed in claim 1, comprising, as component b), one or more active compounds from the group of the ALS inhibitors in combination with one or more agrochemicals which are different from ALS inhibitors.

7. The liquid formulation as claimed in claim 1, comprising
(a) one or derivatives of polycarboxylic acid,
(b) one or more active compounds from the group of the ALS inhibitors,
preferably from the group of the sulfonylureas, and also one or more further components selected from the group consisting of
(a) additional surfactants and/or polymers,
(b) organic solvents,
(c) agrochemicals which are different from ALS inhibitors,
(d) customary formulation auxiliaries,
(e) tank mix components, and/or
(f) water.

8. The liquid formulation as claimed in claim 1, comprising
(a) from 0.1 to 80% by weight of one or more derivatives of polycarboxylic acids,
(b) from 0.001 to 50% by weight of one or more active compounds from the group of the ALS inhibitors, preferably from the group of the sulfonylureas,
(c) from 0 to 60% by weight of additional surfactants and/or polymers,
(d) from 0 to 90% by weight of organic solvents,
(e) from 0 to 50% by weight of agrochemicals which are different from ALS inhibitors,
(f) from 0 to 20% by weight of customary formulation auxiliaries and/or
(h) from 0 to 50% by weight of water.

9. The liquid formulation as claimed in claim 1, comprising
a) from 10 to 60% by weight of one or more derivatives of polycarboxylic acids,
b) from 1 to 15% by weight of one or more active compounds from the group of the ALS inhibitors, preferably from the group of the sulfonylureas,
c) from 0 to 50% by weight of additional surfactants and/or polymers,
d) from 0 to 30% by weight of organic solvents,
e) from 0 to 50% by weight of agrochemicals which are different from ALS inhibitors and/or
f) from 0 to 10% by weight of customary formulation auxiliaries.

10. The liquid formulation as claimed in claim 1 in the form of a solution, dispersion or an emulsion concentrate.

11. A process for preparing a liquid formulation as defined in claim 1, which comprises mixing the components with one another.

12. The process as claimed in claim 11, wherein the components are ground after mixing.

13. A method for controlling undesirable vegetation, which comprises applying an effective amount of a formulation as claimed in claim 1, if required after dilution with water, to the seeds, plants, parts of plants or the area under cultivation.
